(19) United States
(12) Patent Application Publication
(10) Pub. No.: US 2026/0293916 A1
(43) Pub. Date: Oct. 1, 2026

(54) EUTHANASIA CHAMBER FOR RECEIVING INTACT WIRE CAGE TRAPS CONTAINING LIVE ANIMALS AND METHOD OF USE

(71) Applicant: Jennifer Garvey, Alpine, CA (US)

(72) Inventor: Jennifer Garvey, Alpine, CA (US)

(21) Appl. No.: 19/633,390

(22) Filed: Mar. 30, 2026

Related U.S. Application Data
(60) Provisional application No. 63/779,297, filed on Mar. 28, 2025.

(51) Int. Cl. A22B 3/00

(52) U.S. Cl. CPC A22B 3/005

(57) ABSTRACT

A squirrel euthanizer chamber may include an enclosure body defining an inner chamber sized to receive an entire live-capture squirrel trap containing a squirrel. A door can be movable relative to the enclosure body between an open position for insertion of the live-capture squirrel trap into the inner chamber and a closed position. A gas inlet may be configured to introduce gas into the inner chamber. The door and the enclosure body are configured to provide an airtight or substantially airtight closure such that a gas is retained within the chamber while the squirrel remains inside the live-capture squirrel trap as the gas is introduced into the inner chamber. The chamber interior is free of internal electronics and includes substantially smooth interior surfaces configured to be washed by hose after use.

### RELATED APPLICATIONS

This application claims the benefit of U.S. Provisional Application Ser. No. 63,779/297 filed Mar. 28, 2025 entitled SQUIRREL TRAP the entire disclosure of which is herein incorporated by reference.

### FIELD OF THE INVENTION

This application relates generally to animal control equipment, and more particularly to a manually operated euthanasia enclosure for humane post-capture euthanasia of small animals.

### BACKGROUND OF THE INVENTION

Live trapping of nuisance animals such as squirrels is a widely practiced method of wildlife control in residential and commercial settings. Commercially available wire-frame live traps, such as those sold under the Squirrelinator and Wilco brand names, are designed to capture small animals alive and unharmed by means of a spring-loaded door mechanism triggered when the animal disturbs a bait pedal inside the trap. While such traps are effective at capturing animals, they leave the user with the problem of disposing of the live animal after capture. Conventional disposal methods include shooting and drowning. Drowning, however, has been prohibited as a method of animal disposal in certain jurisdictions, including the State of California, due to animal welfare concerns. Shooting presents its own practical and safety limitations in residential environments. No dedicated, simple, consumer-level device exists for humanely euthanizing a small animal while it remains inside a commercially available wire-frame live trap, without requiring the animal to be transferred to a separate enclosure.

The prior art discloses various devices that combine animal capture and killing functions into a single integrated unit. EP 0251903 discloses a trap for rodents and other animals comprising an enclosure formed by a conduit with spring-loaded doors held open by a nichrome wire incorporated into an electrical circuit. When an animal disturbs a sliding bait support, the electrical circuit closes, the wire breaks, and the doors snap shut. Upon door closure, a striking pin pierces a gas cartridge mounted on the door, automatically releasing carbon dioxide into the sealed enclosure to asphyxiate the captured animal. This device integrates capture and kill functions into a single automated unit. Similarly, JP 3065150 U discloses a mouse-trapping device in which an intrusion sensor detects a mouse entering a guide pipe, activates a compressor to propel the mouse via compressed air into a capture chamber, and then triggers a release valve on a carbon dioxide cylinder to asphyxiate the animal automatically. This device relies on motorized, sensor-driven components. CA 2631251 discloses a rodent trap in which a solenoid valve, activated by a sensor, releases a blast of compressed air sufficient to kill the rodent upon impact and propel the carcass into a downstream disposal chamber. This device is automated, pressurized, and integrated.

U.S. Pat. No. 6,088,948 discloses a device for trapping rats and mice in which an electronic control unit counts animal visits to an entrance compartment via a photoelectric sensor, and activates a drop door only after a predetermined number of visits, allowing the animal to fall into an underlying killing chamber pre-filled with carbon dioxide. The capture and kill functions are fully integrated into the device, which relies on electronic sensors, counters, and automated gas management. US 20110078940 discloses a single-use, hermetically sealing mousetrap in which an internally mounted carbon dioxide canister is automatically pierced by a setting bar when a mouse steps on a bait pedal, releasing gas into the sealed enclosure. The trap is a self-contained, disposable unit with an automatic door and internally fired gas mechanism. WO 2016/055804 discloses an autonomous animal-trapping device in which an animal enters a receptacle directly, an electronic sensor activates a solenoid to close and seal the door, and air is subsequently removed from the sealed chamber via a valve to kill the animal by hypoxia. The device incorporates electronic sensors, solenoid latches, automatically sealing doors, and wireless communication capability, and the animal enters the device directly rather than being introduced inside a pre-existing cage.

JP 2020156384 discloses a pest extermination set comprising an extermination box configured to be connected to an existing vermin trap and a gas supply source. In the disclosed system, the extermination box is attached to a rear discharge door of the trap, the animal is actively transferred from the trap into the extermination box through a sliding shutter mechanism, the shutter is then closed to seal the animal inside the extermination box, and the extermination box is separated from the trap before gas is introduced. The system requires a specialized trap having a dedicated vermin discharge door separate from the capture entrance, a sliding shutter plate, a mounting portion for connecting the extermination box to the trap opening, and a gas supply system comprising a gas cylinder, pressure regulator, connecting tube, and gas inflow port. The animal must be actively moved, or induced to move, from the trap into the extermination box through the shutter mechanism before euthanasia can proceed. This system does not accept a standard commercially available wire cage trap inserted whole into the enclosure, does not permit the user to introduce gas manually through a simple port or valve without a pressure regulator and connecting tube assembly, and requires animal transfer between the trap and the extermination box as an essential step in the process.

Conventional approaches may require transfer of a captured squirrel from a live-capture trap into a separate kill chamber, or may rely on integrated capture-and-kill trap structures that are dedicated to both capture and euthanization. Such arrangements may increase handling steps and user danger, may complicate chamber cleaning, and may limit compatibility with commercially available live-capture traps. Accordingly, a need exists in the art for a passive, non-electronic, manually operated euthanasia enclosure that is dimensionally configured to receive a complete, commercially available wire-frame live trap containing a pre-captured animal, and can be easily cleaned out with a hose.

### SUMMARY OF THE INVENTION

As described herein, a passive, non-electronic, manually operated euthanizer chamber may address handling and containment issues associated with treatment of captured squirrels. In various embodiments, a squirrel euthanizer chamber may provide a separate enclosure that receives an entire live-capture squirrel trap while the squirrel remains inside the live-capture squirrel trap. The enclosure may include a door that permits insertion and removal of the live-capture squirrel trap as a unit and may cooperate with an enclosure body to provide an airtight or substantially airtight chamber for gas treatment. The enclosure may further include smooth interior surfaces configured for wash-down cleaning and may include one or more gas inlets configured for connection to different gas sources.

The squirrel euthanizer chamber can include an enclosure body defining an inner chamber sized to receive an entire live-capture squirrel trap containing a squirrel, a door movable relative to the enclosure body between an open position for insertion of the live-capture squirrel trap into the inner chamber and a closed position, and a gas inlet configured to introduce gas into the inner chamber, wherein the door and the enclosure body are configured to provide an airtight or substantially airtight closure such that a gas is retained within the chamber while the squirrel remains inside the live-capture squirrel trap as the gas is introduced into the inner chamber.

In an embodiment, a squirrel euthanizer chamber may include an enclosure body that may define an inner chamber sized to receive an entire live-capture squirrel trap containing a squirrel. The squirrel euthanizer chamber may include a door movable relative to the enclosure body between an open position for insertion of the live-capture squirrel trap into the inner chamber and a closed position. The squirrel euthanizer chamber may include a gas inlet configured to introduce gas into the inner chamber. The door and the enclosure body may be configured to provide an airtight or substantially airtight closure such that a gas may be retained within the chamber while the squirrel remains inside the live-capture squirrel trap as the gas is introduced into the inner chamber.

The inner chamber may be configured to receive a commercially available live-capture squirrel trap. The door may be the only access opening through which the live-capture squirrel trap is inserted into and removed from the inner chamber. A seal may be disposed on the door or on a mating surface of the enclosure body. The door may be a front wall door. The door may be a roof door. The door may be a clamshell door including a roof portion and a wall portion. The enclosure body may include a unitary floor, wall, and roof structure. The gas inlet may be configured for connection to a vehicle exhaust hose. The gas inlet may be configured for connection to a compressed-gas line. The inner chamber may have substantially smooth interior surfaces, the chamber interior may be free of internal electronics, and the chamber may be configured to be washed by hose after use.

In an embodiment, a method of euthanizing a squirrel may include capturing the squirrel in a live-capture squirrel trap. The live-capture squirrel trap containing the squirrel may be placed into an inner chamber of a squirrel euthanizer chamber. A door of the squirrel euthanizer chamber may be closed to provide an airtight or substantially airtight closure. A gas may be introduced into the inner chamber while the squirrel remains inside the live-capture squirrel trap.

The squirrel euthanizer chamber may be connected to a vehicle exhaust source. The squirrel euthanizer chamber may be connected to a compressed-gas cylinder. The live-capture squirrel trap may be positioned in the inner chamber before capture of the squirrel. The squirrel euthanizer chamber may be cleaned after removal of the live-capture squirrel trap. Cleaning the squirrel euthanizer chamber may include directing a pressured water stream into the squirrel euthanizer chamber.

In an embodiment, a system for euthanizing a squirrel may include a live-capture squirrel trap configured to contain the squirrel. The system may include a squirrel euthanizer chamber having an enclosure body that may define an inner chamber sized to receive the live-capture squirrel trap. The squirrel euthanizer chamber may include a door movable relative to the enclosure body between an open position and a closed position. The squirrel euthanizer chamber may include a gas inlet configured to introduce gas into the inner chamber. The system may include a gas source coupled to the gas inlet. The door and the enclosure body may be configured to provide an airtight or substantially airtight closure such that the squirrel remains inside the live-capture squirrel trap while gas from the gas source is introduced into the inner chamber. The gas inlet may be configured for connection to a vehicle exhaust hose.

These and other features and advantages of the present description will be apparent to those skilled in the art from the following detailed description of the preferred embodiments and the accompanying drawings.

### BRIEF DESCRIPTION OF THE DRAWINGS

The description below refers to the accompanying drawings, of which:

FIG. 1 is a perspective view of a commercially available squirrel trap, according to an illustrative embodiment;

FIG. 2 is a perspective view of a euthanasia chamber showing the enclosure body with smooth interior surfaces and a sealable door, according to an illustrative embodiment;

FIG. 3 is a cross-sectional view of the euthanasia chamber taken along line 3-3, according to an illustrative embodiment;

FIG. 4 is a perspective view of a euthanasia chamber having a hinged roof door configuration, according to an illustrative embodiment;

FIG. 5 is a perspective view of a euthanasia chamber having a clamshell door configuration, according to an illustrative embodiment;

FIG. 6 is a perspective view of a squirrel trap positioned inside the euthanasia chamber, according to an illustrative embodiment;

FIG. 7 is a perspective view of the euthanasia chamber with the door sealed and connected to an automobile exhaust system, according to an illustrative embodiment;

FIG. 8 is a perspective view of the euthanasia chamber with the door sealed and connected to a bottled gas supply, according to an illustrative embodiment; and

FIG. 9 is a flowchart illustrating a method of euthanizing a squirrel or other small rodent using the squirrel euthanizer chamber system, according to an illustrative embodiment.

### DETAILED DESCRIPTION

The description below sets forth illustrative embodiments of a squirrel euthanizer chamber system and related methods of use. Features described in connection with one embodiment may also be used in other embodiments. The described arrangements may be varied in structure, configuration, size, materials, and operation.

Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. The figures are provided to illustrate selected embodiments and relationships among components of the squirrel euthanizer chamber system. The figures may not be drawn to scale. Relative positions and orientations shown in the figures may vary in other embodiments.

Moreover, various features are described which may be exhibited by some embodiments and not by others. Similarly, various features are described which may be included in some embodiments but not in other embodiments. All illustrations of the drawings are for the purpose of describing selected versions of the present invention and are not intended to limit the scope of the present invention. In various embodiments, the squirrel euthanizer chamber system may include structural features and operational steps that may be used individually or in combination. Specific examples are described below with reference to the figures.

The squirrel euthanizer chamber system described herein provides a secondary enclosure configured to receive an entire commercially available live-capture squirrel trap, together with the squirrel contained therein, so that a euthanizing gas may be introduced into the enclosure while the squirrel remains inside the trap. In various embodiments, the system may include a squirrel euthanizer chamber comprising an enclosure body defining an inner chamber, a door movable between an open position and a closed position, and a gas inlet configured to introduce gas into the inner chamber. The door and the enclosure body may be configured to provide an airtight or substantially airtight closure so that gas introduced into the inner chamber is retained therein during the euthanization process. The squirrel euthanizer chamber may be used in conjunction with commercially available live-capture squirrel traps, such as wire cage traps of the type sold under trade names including Squirrelinator and Wilco, among others, without requiring any modification to the trap or any transfer of the squirrel from the trap to a separate killing space. In various embodiments, the squirrel trap, the squirrel euthanizer chamber, and a selected gas source may together form a squirrel euthanizer system in which the squirrel trap is received within the inner chamber and gas from the gas source is delivered into the inner chamber through one or more gas inlets.

In various embodiments, the squirrel euthanizer chamber may be constructed without internal electronics, sensors, automated mechanisms, motors, compressors, or solenoids. The inner chamber may present substantially smooth interior surfaces that are free of gaps, moving parts, and electronic components, so that the interior may be cleaned by directing a high-pressure water stream, such as from a garden hose, into the chamber after use. The gas inlet may be configured for connection to a vehicle exhaust hose, allowing carbon monoxide from automobile exhaust to be introduced into the inner chamber, or may be configured for connection to a compressed-gas line or cylinder, allowing carbon dioxide or another suitable euthanizing gas to be introduced. In various embodiments, the squirrel euthanizer chamber may be dimensioned to receive the entire live-capture squirrel trap as a unit, so that no transfer of the squirrel from one space to another is required, and the user may simply place the closed trap containing the squirrel into the inner chamber, close and seal the door, and introduce gas through the gas inlet to euthanize the squirrel.

The small animal euthanizer described herein is described as a squirrel euthanizer for ease of description, however, it should be clear that the euthanizer described herein can be used with various small animals, and is not intended to be limited to squirrels. In various embodiments, the squirrel euthanizer chamber system may be used with animals other than squirrels. For example, the squirrel trap and the squirrel euthanizer chamber used with a captured small animal, a rodent, or another nuisance animal that may be retained within a live-capture trap and treated within the inner chamber. In various embodiments, the structural and operational features described herein for the squirrel trap and the squirrel euthanizer chamber may be applied to traps and chamber sizes selected for the intended animal type.

In various embodiments, the term squirrel may refer to one example of a target animal that may be captured in a live-capture trap and treated within the squirrel euthanizer chamber. In other embodiments, the target animal may include a rat, a mouse, a chipmunk, or another small animal that may be retained within a live-capture trap sized for insertion into the inner chamber. The dimensions of the inner chamber, the dimensions of the squirrel trap, and the duration or amount of introduced gas may be varied based on the size of the target animal, the trap geometry, and the intended treatment conditions.

In various embodiments, the squirrel euthanizer chamber may therefore be described as a trap-receiving euthanizer chamber configured to receive a live-capture trap containing a captured animal while the captured animal remains inside the live-capture trap during treatment. The use of squirrel-specific terminology in certain examples and figures may provide one implementation context and may not limit application of the disclosed chamber structure and treatment methods to only squirrels.

In various embodiments, non-target animals may accidentally be caught in the live-capture trap. In these cases, the user is free to use their own judgment and can release non-target animals without euthanization. The manual, non-automatic nature of the present invention prevents mistaken euthanization of non-target animals, small pets, or other animals that may be illegal or undesirable to euthanize.

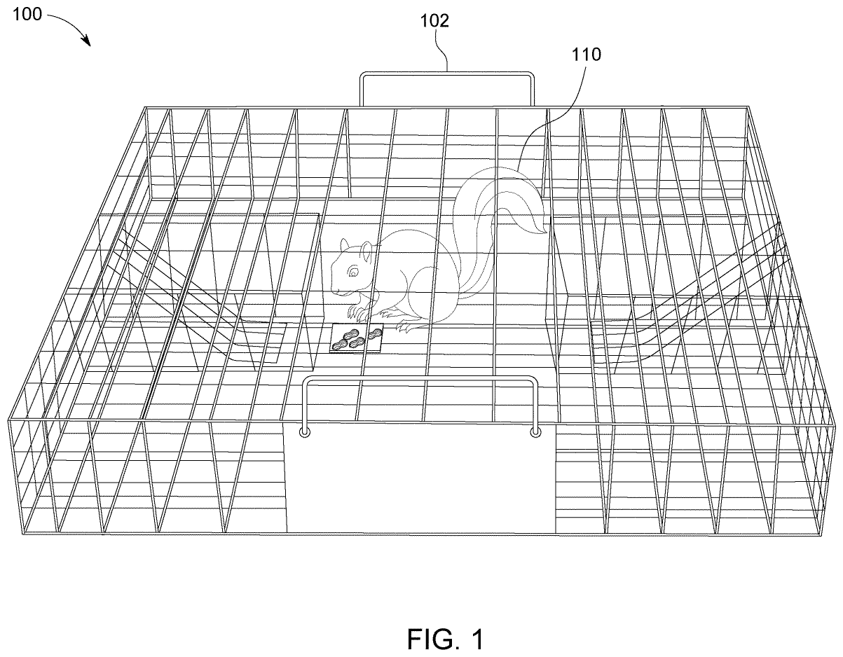

FIG. 1 is a perspective view of a commercially available squirrel trap, according to an illustrative embodiment. As shown in FIG. 1, a squirrel trap 100 may be a wire frame cage trap of the type commercially available for live capture of squirrels and similar small animals. The squirrel trap 100 may include a wire frame body defining an interior space sized to contain a squirrel 110. In various embodiments, the squirrel trap 100 may include one or more handles 102 disposed on the exterior of the trap body to facilitate carrying and placement of the squirrel trap 100. The squirrel trap 100 may be configured so that bait may be placed inside the trap body, and a squirrel 110 may enter the trap body to reach the bait, triggering a door or gate mechanism that closes behind the squirrel 110 and prevents the squirrel 110 from exiting the trap. The squirrel 110 may remain alive inside the squirrel trap 100 until the user takes further action. In various embodiments, the squirrel trap 100 may be a commercially available wire cage trap, such as those sold under the trade names Squirrelinator or Wilco, or other wire frame traps having similar overall dimensions. The squirrel trap 100 may be used as a component of the squirrel euthanizer chamber system described herein, wherein the entire squirrel trap 100, with the squirrel 110 inside, may be placed into the inner chamber of the squirrel euthanizer chamber for euthanization, without requiring any transfer of the squirrel 110 from the squirrel trap 100 to a separate space.

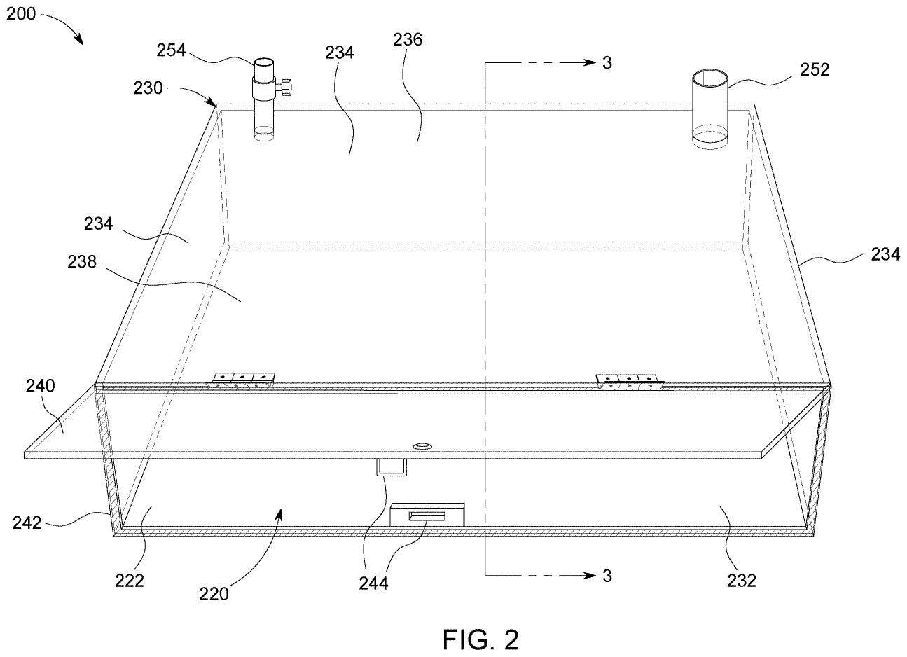

FIG. 2 is a perspective view of a euthanasia chamber with an enclosure body and a front door, and showing the enclosure body with smooth interior surfaces, according to an illustrative embodiment. As shown in FIG. 2, a squirrel euthanizer chamber 200 may include an enclosure body 230 defining an inner chamber 220 sized to receive an entire live-capture squirrel trap 100 containing a squirrel 110. The enclosure body 230 may include a bottom panel 232, one or more walls 234, a back wall 236, and a roof 238, which may be formed as a unitary structure so that the enclosure body 230 is made as a single component. In various embodiments, the unitary construction of the enclosure body 230 may eliminate gaps, seams, and joints on the interior surfaces of the inner chamber 220, facilitating cleaning of the inner chamber 220 after use. A floor surface 222 of the inner chamber 220 may be substantially smooth and free of protrusions, electronics, or moving parts, so that the inner chamber 220 may be washed out with a high-pressure water stream after use without concern for damage to internal components.

The squirrel euthanizer chamber 200 may include a door 240 movable relative to the enclosure body 230 between an open position for insertion of the squirrel trap 100 into the inner chamber 220 and a closed position. In various embodiments, as shown in FIG. 2, the door 240 may be a front wall door, forming one of the walls of the squirrel euthanizer chamber 200 when in the closed position. The door 240 may be hinged along one edge to the enclosure body 230, or may be otherwise movably attached, so that the door 240 may be swung or moved to the open position to allow the squirrel trap 100 to be inserted into or removed from the inner chamber 220. In various embodiments, the door 240 may be the only access opening through which the squirrel trap 100 is inserted into and removed from the inner chamber 220, so that no additional openings or transfer mechanisms are required.

A seal 242 may be disposed on the door 240 or on a mating surface of the enclosure body 230, so that when the door 240 is in the closed position, the door 240 and the enclosure body 230 together provide an airtight or substantially airtight closure. In various embodiments, the seal 242 may be a rubber gasket, an elastomeric seal, or another compressible sealing element configured to conform to the mating surfaces of the door 240 and the enclosure body 230 when the door 240 is closed. A latch 244 may be provided on the door 240 or the enclosure body 230 to secure the door 240 in the closed position and maintain compression of the seal 242 during gas introduction.

The squirrel euthanizer chamber 200 may include one or more gas inlets configured to introduce gas into the inner chamber 220. In various embodiments, an exhaust intake port 252 may be disposed on the back wall 236 or another wall of the enclosure body 230, and may be configured for connection to a vehicle exhaust hose, so that carbon monoxide from automobile exhaust may be directed into the inner chamber 220. In various embodiments, an airline connection valve 254 may be disposed on the enclosure body 230, in addition to or instead of the exhaust intake port. The airline connection valve 254 may be configured for connection to a compressed-gas line or cylinder, so that carbon dioxide or another euthanizing gas may be introduced into the inner chamber 220 through the airline connection valve 254. In various embodiments, the exhaust intake port 252 and the airline connection valve 254 may both be present on the enclosure body 230, providing the user with the option of connecting either a vehicle exhaust hose or a compressed-gas line depending on the available gas source. In various embodiments, only one gas inlet may be present. The gas inlet or inlets may be located on the back wall 236, a side wall, or another surface of the enclosure body 230, and the location may be selected to facilitate connection of a hose or gas line by the user.

In various embodiments, the inner chamber 220 may be dimensioned to receive a commercially available live-capture squirrel trap 100, such as those sold under the trade names Squirrelinator or Wilco, or other wire cage traps having similar overall dimensions. The inner chamber 220 may be enlarged slightly relative to the outer dimensions of the squirrel trap 100 to ensure that the squirrel trap 100 may be inserted and removed without difficulty, and to accommodate squirrel traps of varying dimensions within a range of commercially available products. In various embodiments, the squirrel euthanizer chamber 200 may have no internal electronics, no automated mechanisms, no sensors, and no moving parts other than the door 240 and any associated latch 244 or hinge components.

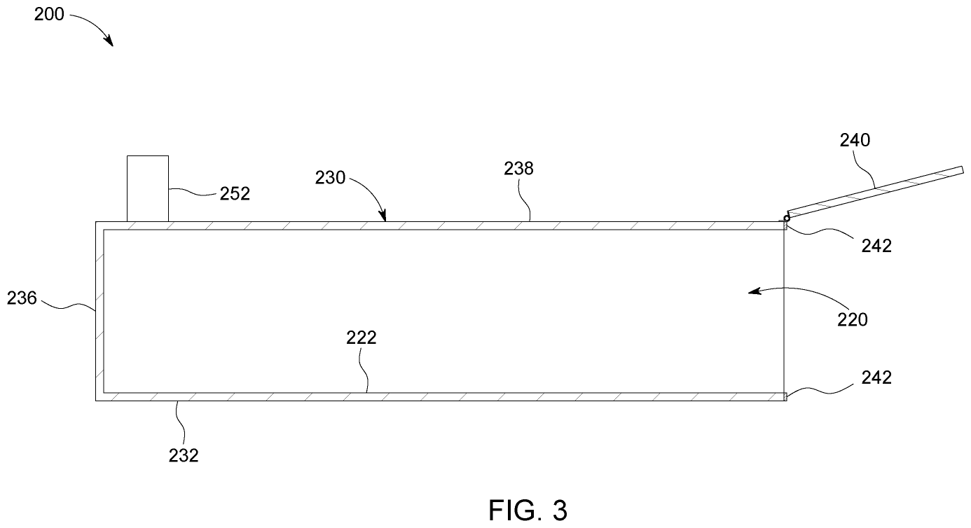

FIG. 3 is a cross-sectional view of the squirrel euthanizer chamber of FIG. 2, taken along cross-section line 3-3, according to an illustrative embodiment. As shown in FIG. 3, the squirrel euthanizer chamber 200 may define the inner chamber 220 above the floor surface 222 within the enclosure body 230. The squirrel euthanizer chamber 200 is shown in cross-section, revealing the inner chamber 220 defined by the enclosure body 230. The cross-sectional view may show the bottom panel 232, the back wall 236, and the roof 238 of the enclosure body 230, as well as the floor surface 222 of the inner chamber 220. The door 240 is shown in the open position, with the seal 242 disposed on the mating surface of the enclosure body 230 to provide an airtight or substantially airtight closure. In various embodiments, a seal 242 may be disposed on the enclosure body 230, the door 240, or both. The exhaust intake port 252 may be seen extending through the enclosure body, providing a passage for gas to be introduced into the inner chamber 220 from outside the squirrel euthanizer chamber 200.

The cross-sectional view of FIG. 3 shows that the inner chamber 220 may be substantially free of internal electronics, internal actuators, and internal moving parts. The inner chamber 220 may also be substantially free of gaps and crevices that would impede cleaning. In various embodiments, the smooth interior surfaces of the inner chamber 220 may facilitate cleaning of the chamber after use, as debris, biological material, or residual gas may be removed by directing a high-pressure water stream, such as from a standard garden hose, into the inner chamber 220 through the open door 240. The cross-sectional view may also illustrate the relationship between the door 240 and the enclosure body 230, showing how the seal 242 may be compressed between the door 240 and the enclosure body 230 when the door 240 is in the closed position to provide an airtight or substantially airtight closure. In various embodiments, the seal 242 may be located on the door 240, on the enclosure body 230, or on both, and may be configured to conform to the mating surfaces to prevent gas from escaping the inner chamber 220 during the euthanization process.

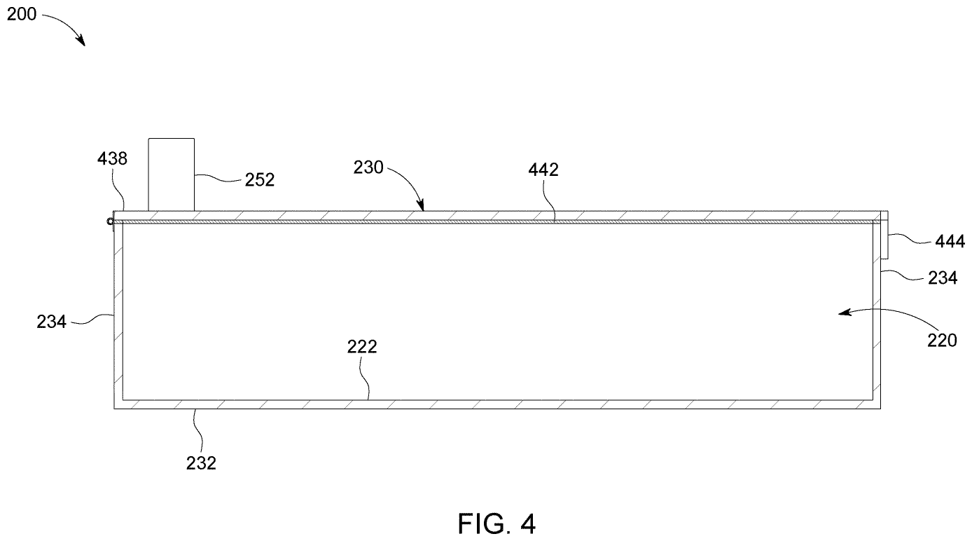

FIG. 4 is a perspective view of a euthanasia chamber having a hinged roof door configuration, according to an illustrative embodiment. As shown in FIG. 4, in various embodiments, the squirrel euthanizer chamber 200 may be configured with a hinged roof 438 serving as the door, rather than a front wall door as shown in FIG. 2. The enclosure body 230 may include a bottom panel 232 and walls 234 formed as a unitary structure, with the hinged roof 438 movably attached to the enclosure body 230 along one edge so that the hinged roof 438 may be opened to allow the squirrel trap 100 to be inserted into the inner chamber 220 from above, and then closed to seal the inner chamber 220. In various embodiments, the hinged roof 438 may be hinged along a rear edge, a front edge, or a side edge of the enclosure body 230, depending on the intended orientation of use. A seal 442 may be disposed on the hinged roof 438 or on the mating upper rim of the enclosure body 230, so that when the hinged roof 438 is in the closed position, an airtight or substantially airtight closure is provided. A latch 444 may be provided to secure the hinged roof 438 in the closed position and maintain compression of the seal 442.

The squirrel euthanizer chamber 200 of FIG. 4 may include an exhaust intake port 252 and/or an airline connection valve 254 disposed on one or more walls 234 of the enclosure body 230, configured for connection to a vehicle exhaust hose or a compressed-gas line, respectively, as described with respect to FIG. 2. The interior surfaces of the inner chamber 220 may be substantially smooth and free of protrusions, electronics, or moving parts, facilitating cleaning after use. In various embodiments, the roof door configuration of FIG. 4 may be particularly suited for use cases where the squirrel trap 100 is to be lowered vertically into the inner chamber 220.

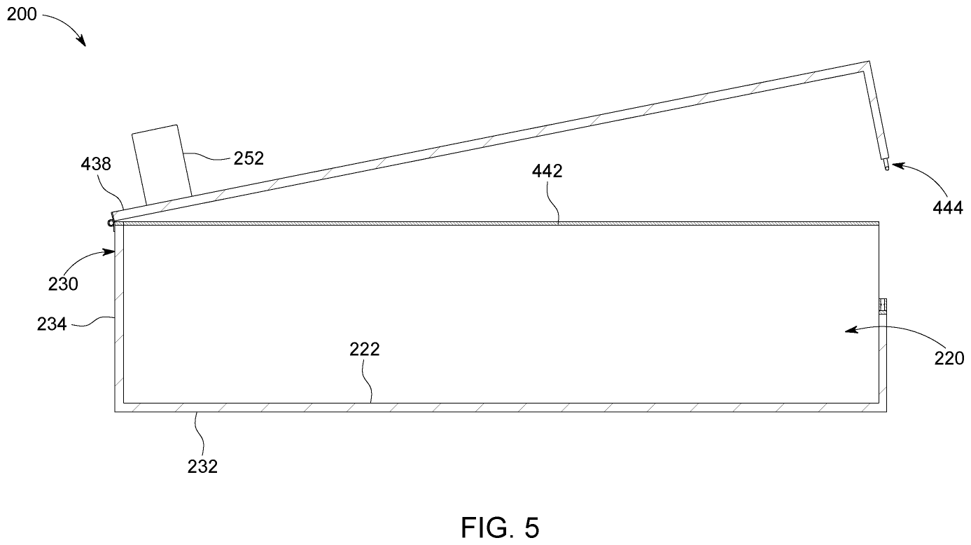

FIG. 5 is a perspective view of a euthanasia chamber having a clamshell door configuration, according to an illustrative embodiment. As shown in FIG. 5, in various embodiments, the squirrel euthanizer chamber 200 may be configured with a clamshell door comprising a hinged roof 438 and at least a portion of one or more walls 234, so that when the clamshell door is opened, the roof and at least a portion of one or more walls hinge away from the enclosure body 230 together, providing a wide opening for insertion of the squirrel trap 100 into the inner chamber 220. The enclosure body 230 may include a bottom panel 232 and a lower portion of the walls 234 formed as a unitary structure, with the clamshell door comprising the upper portion of one or more walls 234 and the roof, movably attached to the enclosure body 230 along a hinge line. In various embodiments, the clamshell door may hinge along a rear edge, a front edge, or a side edge of the enclosure body 230. In various embodiments, the clamshell door may hinge along a break line within rear wall, a front wall, or a side wall of the enclosure body 230.

A seal 442 may be disposed on the clamshell door or on the mating surface of the enclosure body 230, so that when the clamshell door is in the closed position, an airtight or substantially airtight closure is provided between the clamshell door and the enclosure body 230. A latch 444 may be provided to secure the clamshell door in the closed position and maintain compression of the seal 442 during gas introduction. The squirrel euthanizer chamber 200 of FIG. 5 may include an exhaust intake port 252 and an airline connection valve 254 disposed on one or more walls 234 or on the clamshell door, configured for connection to a vehicle exhaust hose or a compressed-gas line, respectively. The floor surface 222 of the inner chamber 220 may be substantially smooth and free of protrusions, electronics, or moving parts, facilitating cleaning after use. In various embodiments, the clamshell door configuration of FIG. 5 may provide a particularly wide opening for insertion and removal of the squirrel trap 100.

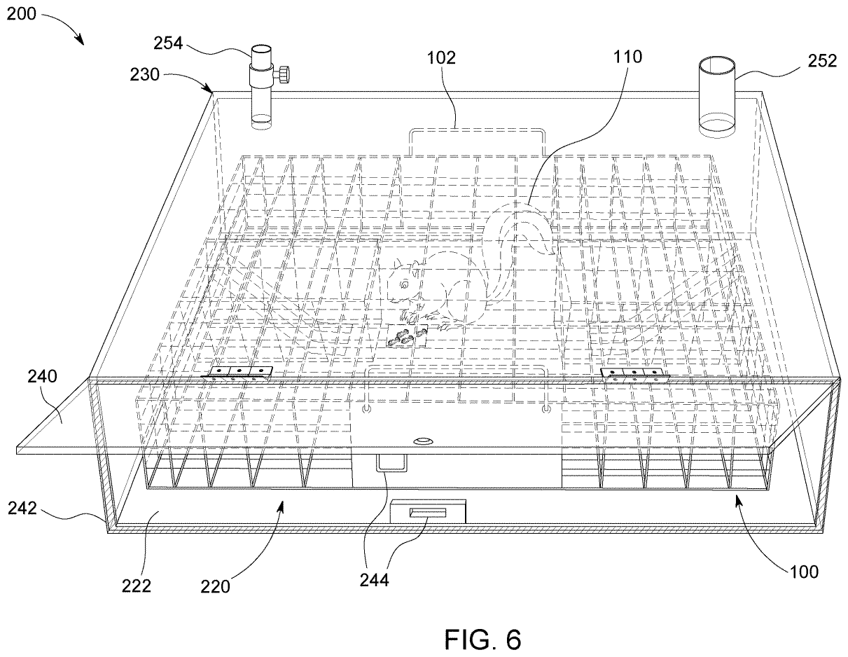

FIG. 6 is a perspective view of a squirrel trap positioned inside the euthanasia chamber, according to an illustrative embodiment. As shown in FIG. 6, the squirrel trap 100, with the squirrel 110 inside, may be placed into the inner chamber 220 of the squirrel euthanizer chamber 200 through the open door 240. The squirrel trap 100 may be positioned on the floor surface 222 of the inner chamber 220, with the handles 102 of the squirrel trap 100 accessible to the user for placement and removal. The inner chamber 220 may be sized to receive the entire squirrel trap 100 as a unit, so that the squirrel trap 100 fits within the enclosure body 230 without requiring any modification to the squirrel trap 100 or any transfer of the squirrel 110 from the squirrel trap 100 to a separate space. In various embodiments, the inner chamber 220 may be dimensioned to accommodate commercially available wire cage squirrel traps of varying sizes within a range of standard dimensions.

Once the squirrel trap 100 has been placed into the inner chamber 220, the door 240 may be closed and secured with the latch 244, compressing the seal 242 between the door 240 and the enclosure body 230 to provide an airtight or substantially airtight closure. The exhaust intake port 252 and/or the airline connection valve 254 may be visible on the enclosure body 230, ready for connection to a gas source. In various embodiments, an airtight door may be sealed and the squirrel may be suffocated within the chamber without the need for gas. In various embodiments, the exhaust intake port 252 and/or airline connection valve 254 can be closed and sealed to allow suffocation and/or to retain gasses trapped within the chamber.

In various embodiments, the squirrel euthanizer chamber 200 may be used with the squirrel trap 100 already inside the inner chamber 220 before the squirrel 110 is captured, so that the door 240 may be closed after the squirrel 110 enters the squirrel trap 100 and triggers the trap mechanism, without requiring the user to handle the squirrel trap 100 after capture. In other embodiments, the squirrel trap 100 may be placed into the inner chamber 220 after the squirrel 110 has already been captured, and the door 240 may then be closed and sealed.

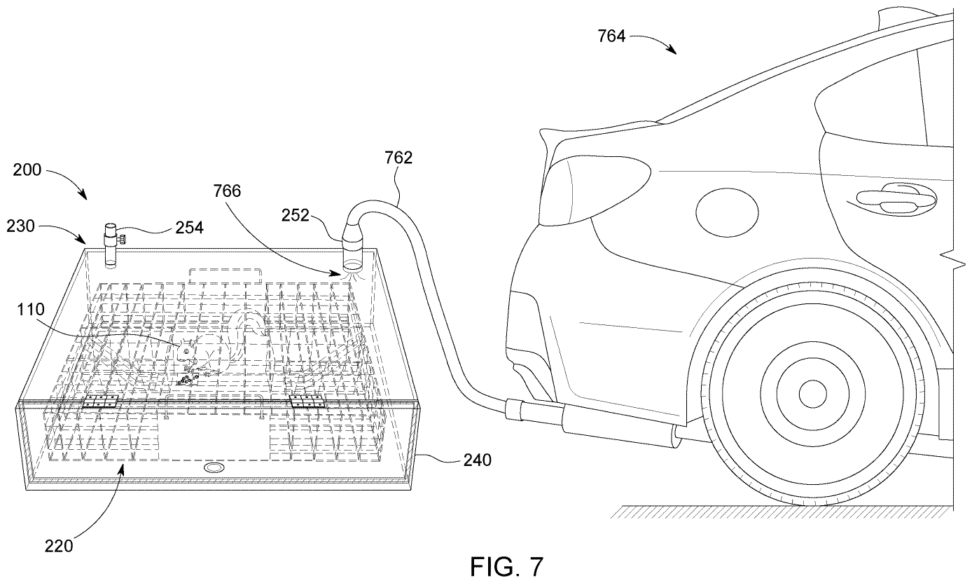

FIG. 7 is a perspective view of a squirrel trap holding a squirrel, wherein the squirrel trap has been placed inside the squirrel euthanizer chamber, the door has been closed and latched, and a hose has been connected from a vehicle exhaust to the exhaust intake port, according to an illustrative embodiment. As shown in FIG. 7, after the squirrel trap 100 has been placed into the inner chamber 220 of the squirrel euthanizer chamber 200 and the door 240 has been closed and latched, a hose 762 may be connected between the exhaust 766 of an automobile 764 and the exhaust intake port 252 of the squirrel euthanizer chamber 200. In various embodiments, the hose 762 may be a flexible conduit, such as a rubber or plastic hose, sized to fit over or into the exhaust intake port 252 and to connect to the exhaust pipe of the automobile 764. The exhaust intake port 252 may be configured to receive hoses of varying diameters, and may include a rubber skirt, a flexible collar, or another fitting to accommodate different hose sizes and provide a reasonably gas-tight connection between the hose 762 and the exhaust intake port 252.

When the automobile 764 is running, carbon monoxide gas from the exhaust 766 may flow through the hose 762, through the exhaust intake port 252, and into the inner chamber 220 of the squirrel euthanizer chamber 200. Because the door 240 is closed and sealed, the carbon monoxide gas may accumulate within the inner chamber 220 and within the squirrel trap 100, which may be a wire cage trap through which gas may freely pass. The squirrel 110 inside the squirrel trap 100 may be exposed to the carbon monoxide gas and may be euthanized within a period of several minutes. In various embodiments, the user may monitor the process and, after the squirrel 110 has been euthanized, may disconnect the hose 762, open the door 240, and remove the squirrel trap 100 from the inner chamber 220. The squirrel 110 may then be disposed of, and the inner chamber 220 may be cleaned by directing a high-pressure water stream into the chamber through the open door 240.

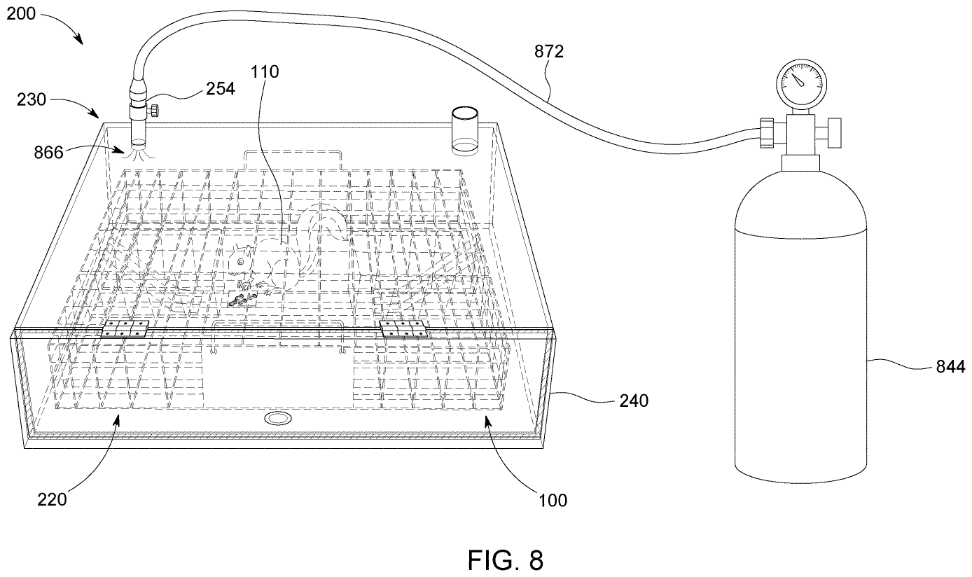

FIG. 8 is a perspective view of a squirrel trap holding a squirrel, wherein the squirrel trap has been placed inside the squirrel euthanizer chamber, the door has been closed and latched, and an airline has been connected from a gas cylinder to the airline connection valve, according to an illustrative embodiment. As shown in FIG. 8, in various embodiments, a gas cylinder 844 may be connected to the airline connection valve 254 of the squirrel euthanizer chamber 200 by an airline 872. The gas cylinder 844 may contain carbon dioxide, carbon monoxide, or another euthanizing gas or suffocating gas 866 suitable for euthanizing the squirrel 110. The airline 872 may be a flexible conduit, such as a rubber or plastic hose or a metal-reinforced gas line, configured to connect the gas cylinder 844 to the airline connection valve 254. In various embodiments, the airline connection valve 254 may be a standard compressed-gas fitting, such as a Schrader valve, a barbed fitting, or another fitting compatible with commercially available compressed-gas lines and cylinders.

When the gas cylinder 844 is opened, gas 866 may flow from the gas cylinder 844 through the airline 872, through the airline connection valve 254, and into the inner chamber 220 of the squirrel euthanizer chamber 200. Because the door 240 is closed and sealed, the gas 866 may accumulate within the inner chamber 220 and within the squirrel trap 100, exposing the squirrel 110 to the euthanizing gas 866. In various embodiments, the user may control the flow of gas 866 by operating a valve on the gas cylinder 844 or on the airline 872. Specific pressure values, flow rates, and regulator settings may be selected based on the selected gas source, chamber volume, and treatment protocol. After the squirrel 110 has been euthanized, the user may close the gas cylinder 844, disconnect the airline 872, open the door 240, and remove the squirrel trap 100 from the inner chamber 220. In various embodiments, the squirrel euthanizer chamber 200 may include a vent or release valve to allow residual gas to be safely vented from the inner chamber 220 before the door 240 is opened. The squirrel 110 may then be disposed of, and the inner chamber 220 may be cleaned as described above.

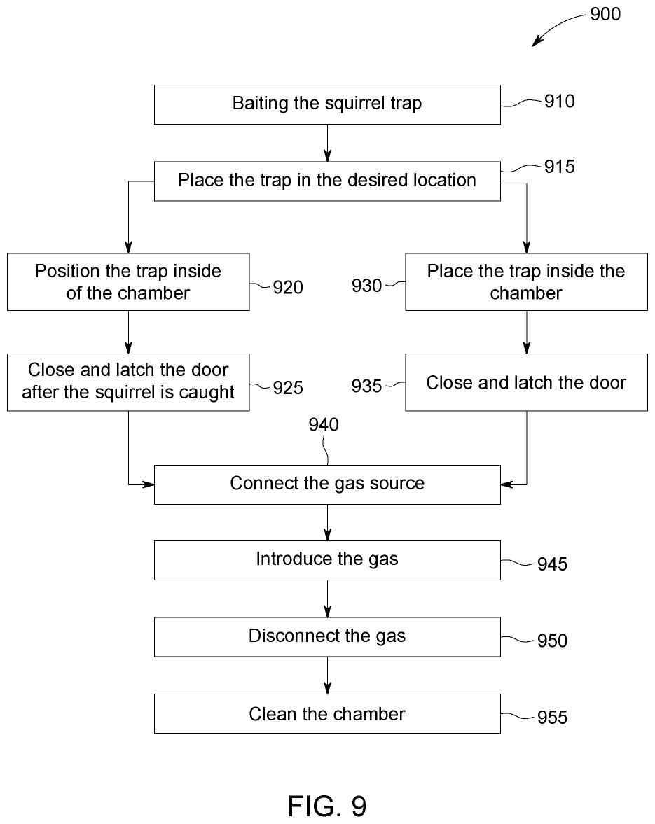

FIG. 9 is a flowchart illustrating a method of euthanizing a squirrel or other small rodent using the squirrel euthanizer chamber system, according to an illustrative embodiment. As shown in FIG. 9, a method 900 of euthanizing a squirrel may include a number of activities that may be performed by a user employing the squirrel euthanizer chamber system described herein. In various embodiments, the method may begin at box 910 with baiting the squirrel trap. Baiting the squirrel trap can include placing bait inside the trap body to attract a squirrel. At box 915, the squirrel trap may then be positioned in a location where squirrel activity has been observed, and the trap mechanism may be set so that a squirrel entering the trap body will trigger the door or gate to close, capturing the squirrel alive inside the squirrel trap. The user may optionally set the trap without the chamber, or may set the trap within the chamber.

In various embodiments, at box 920 the squirrel trap may be positioned inside the inner chamber of the squirrel euthanizer chamber before the squirrel is captured, so that the squirrel trap and the squirrel euthanizer chamber may be used together as a single unit. In this case, the door of the squirrel euthanizer chamber may be left open while the squirrel trap is set. In this case, at box 925 the door may be closed, latched, and sealed after the squirrel has been captured within the trap that is inside of the chamber.

In other embodiments, the squirrel trap may be used independently to capture the squirrel, and at box 930 the squirrel trap may then be placed into the inner chamber of the squirrel euthanizer chamber after capture. The method may include opening the door of the squirrel euthanizer chamber, and placing the squirrel trap containing the squirrel entirely inside the inner chamber. At box 935, the door can be closed, latched, and sealed. The method may include closing the door, and the door may be latched with the latch to secure the door in the closed position and compress the seal between the door and the enclosure body, providing an airtight or substantially airtight closure.

At box 940, the method may optionally include connecting a gas source to the squirrel euthanizer chamber, either by connecting a hose from the exhaust of an automobile to the exhaust intake port, or by connecting an airline from a gas cylinder to the airline connection valve. In various embodiments, gas may be unnecessary, and the squirrel may be allowed to suffocate within the sealed chamber. At box 945, gas may then be introduced into the inner chamber, euthanizing the squirrel while the squirrel remains inside the squirrel trap.

After the squirrel has been euthanized, at box 950 the gas source may be disconnected, the door may be opened, and the squirrel trap may be removed from the inner chamber. The squirrel may be disposed of. At box 955, the inner chamber may be cleaned by directing a high-pressure water stream, such as from a garden hose, into the inner chamber through the open door. In various embodiments, the substantially smooth interior surfaces of the inner chamber, together with the absence of internal electronics, moving parts, and gaps, may facilitate thorough cleaning of the inner chamber after use.

In various embodiments, the squirrel euthanizer chamber may be constructed from materials suitable for outdoor use and repeated cleaning, such as molded plastic, fiberglass, sheet metal, or other durable materials. Seams may be sealed to limit gas leakage and to reduce cleaning crevices. The enclosure body may be formed by injection molding, rotational molding, sheet metal fabrication, or other manufacturing processes, and may be finished with a smooth interior surface to facilitate cleaning. The door may be formed from the same or similar materials as the enclosure body, and may be attached to the enclosure body by one or more hinges, pivots, or other movable connections. The seal may be formed from rubber, silicone, neoprene, or another compressible elastomeric material, and may be attached to the door or the enclosure body by adhesive, mechanical fasteners, or by being molded or extruded into a groove or channel. The latch may be a toggle latch, a draw latch, a cam latch, or another type of fastening mechanism capable of securing the door in the closed position and maintaining compression of the seal.

In various embodiments, the exhaust intake port may be a tubular fitting, a flanged port, or another type of opening configured to receive a hose or tube. The exhaust intake port may be sized to receive a standard automotive exhaust hose, which may have an inner diameter in the range of approximately one inch to four inches, or may be configured with a flexible rubber skirt or collar to accommodate hoses of varying diameters. The airline connection valve may be a standard compressed-gas fitting, such as a Schrader valve, a ball valve, a barbed fitting, or a quick-connect fitting, configured to connect to a standard compressed-gas line or cylinder. [0036] In various embodiments, the enclosure body 230 may include a gas-retention valve in addition to the exhaust intake port 252 or the airline connection valve 254. The gas-retention valve may permit introduced gas to be trapped within the inner chamber 220 until the squirrel 110 has died and may thereafter permit release of the gas. In other embodiments, the exhaust intake port 252 or the airline connection valve 254 may itself provide a valving function. Structural details of such a valve arrangement may vary. In various embodiments, both the exhaust intake port and the airline connection valve may be present on the enclosure body, providing the user with flexibility in selecting a gas source. In other embodiments, only one type of gas inlet may be present. In various embodiments, oxygen deprivation may occur within the sealed squirrel euthanizer chamber without introduction of external gas.

In various embodiments, the inner chamber may have interior dimensions sufficient to receive a commercially available wire cage squirrel trap, such as those having overall dimensions of approximately twenty-four inches in length, seven inches in width, and seven inches in height, or other standard dimensions. The inner chamber may be enlarged slightly relative to the outer dimensions of the squirrel trap to ensure ease of insertion and removal, and to accommodate squirrel traps of varying dimensions within a range of commercially available products. In various embodiments, the inner chamber may have interior dimensions of approximately twenty-six inches in length, nine inches in width, and nine inches in height, or other dimensions selected to accommodate the range of commercially available squirrel traps intended for use with the squirrel euthanizer chamber. In various embodiments, the squirrel euthanizer chamber 200 may be dimensioned for one trap model or for multiple trap models. In various embodiments, the interior geometry, door orientation, inlet location, latch arrangement, seal profile, and material selection may be varied while still permitting the squirrel trap 100 to be placed into the inner chamber 220 and treated therein.

In various embodiments, the squirrel euthanizer chamber may be used in jurisdictions where certain methods of disposing of captured squirrels, such as drowning, may be restricted or prohibited by law, providing a humane and legally compliant alternative for euthanizing captured squirrels. The squirrel euthanizer chamber may be used by homeowners, pest control professionals, wildlife management personnel, or others who need to humanely euthanize captured squirrels without the use of firearms or other methods that may be impractical or unavailable in certain settings.

In various embodiments, the squirrel euthanizer chamber may be used without any gas source, relying solely on the airtight or substantially airtight closure provided by the door and the seal to deprive the squirrel of oxygen within the sealed inner chamber. In such embodiments, the squirrel may be euthanized by suffocation within the sealed inner chamber, without the introduction of any external gas. In other embodiments, a gas may be introduced into the inner chamber to accelerate the euthanization process or to ensure a more rapid and humane outcome.

The squirrel euthanizer chamber may differ from capture-and-kill traps in that the squirrel euthanizer chamber may receive the entire squirrel trap after capture rather than capturing the squirrel directly within the squirrel euthanizer chamber. The squirrel euthanizer chamber may also differ from transfer-box arrangements in that the squirrel may remain inside the original squirrel trap during treatment rather than being transferred from the squirrel trap into a different internal kill compartment. Such arrangements may increase user safety and reduce handling steps, and may permit a simple, cleanable and sanitary chamber structure.

Although this invention has been disclosed in the context of certain preferred embodiments and examples, it should be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Accordingly, this description is meant to be taken only by way of example, and not to otherwise limit the scope of this invention.

What is claimed is:

1. A squirrel euthanizer chamber comprising:
an enclosure body defining an inner chamber sized to receive an entire live-capture squirrel trap containing a squirrel;
a door movable relative to the enclosure body between an open position for insertion of the live-capture squirrel trap into the inner chamber and a closed position; and
a gas inlet configured to introduce gas into the inner chamber,
wherein the door and the enclosure body are configured to provide an airtight or substantially airtight closure such that a gas is retained within the chamber while the squirrel remains inside the live-capture squirrel trap as the gas is introduced into the inner chamber.

2. The squirrel euthanizer chamber of claim 1, wherein the inner chamber is configured to receive a commercially available live-capture squirrel trap.

3. The squirrel euthanizer chamber of claim 1, wherein the door is the only access opening through which the live-capture squirrel trap is inserted into and removed from the inner chamber.

4. The squirrel euthanizer chamber of claim 1, wherein a seal is disposed on the door or on a mating surface of the enclosure body.

5. The squirrel euthanizer chamber of claim 1, wherein the door is a front wall door.

6. The squirrel euthanizer chamber of claim 1, wherein the door is a roof door.

7. The squirrel euthanizer chamber of claim 1, wherein the door is a clamshell door including a roof portion and a wall portion.

8. The squirrel euthanizer chamber of claim 1, wherein the enclosure body includes a unitary floor, walls, and roof structure.

9. The squirrel euthanizer chamber of claim 1, wherein the gas inlet is configured for connection to a vehicle exhaust hose.

10. The squirrel euthanizer chamber of claim 1, wherein the gas inlet is configured for connection to a compressed-gas line.

11. The squirrel euthanizer chamber of claim 1, wherein the inner chamber has substantially smooth interior surfaces, the chamber interior is free of internal electronics, and the chamber is configured to be washed by hose after use.

12. A method of euthanizing a squirrel, the method comprising:
capturing the squirrel in a live-capture squirrel trap;
placing the live-capture squirrel trap containing the squirrel into an inner chamber of a squirrel euthanizer chamber;
closing a door of the squirrel euthanizer chamber to provide an airtight or substantially airtight closure; and
introducing a gas into the inner chamber while the squirrel remains inside the live-capture squirrel trap.

13. The method of claim 12, further comprising connecting the squirrel euthanizer chamber to a vehicle exhaust source.

14. The method of claim 12, further comprising connecting the squirrel euthanizer chamber to a compressed-gas cylinder.

15. The method of claim 12, further comprising positioning the live-capture squirrel trap in the inner chamber before capture of the squirrel.

16. The method of claim 12, further comprising cleaning the squirrel euthanizer chamber after removal of the live-capture squirrel trap.

17. The method of claim 16, wherein cleaning the squirrel euthanizer chamber comprises directing a pressured water stream into the squirrel euthanizer chamber.

18. A system for euthanizing a squirrel, the system comprising:
a live-capture squirrel trap configured to contain the squirrel;
a squirrel euthanizer chamber including an enclosure body defining an inner chamber sized to receive the live-capture squirrel trap, a door movable relative to the enclosure body between an open position and a closed position, and a gas inlet configured to introduce gas into the inner chamber; and
a gas source coupled to the gas inlet,
wherein the door and the enclosure body are configured to provide an airtight or substantially airtight closure such that the squirrel remains inside the live-capture squirrel trap while gas from the gas source is introduced into the inner chamber.

19. The system of claim 18, wherein the gas inlet is configured for connection to a vehicle exhaust hose.
